(19) United States
(12) Patent Application Publication
(10) Pub. No.: US 2015/0177200 A1
(43) Pub. Date: Jun. 25, 2015

(54) CHROMATOGRAPH WITH COLUMN ENGINEERING FOR USE IN OIL AND GAS EXTRACTION

(71) Applicant: Dean John Richards, Fort Worth, TX (US)

(72) Inventor: Dean John Richards, Fort Worth, TX (US)

(21) Appl. No.: 14/133,957

(22) Filed: Dec. 19, 2013

(51) Int. Cl. G01N 30/16; G01N 30/70; G01N 30/68; G01N 30/88; B01J 20/281

(52) U.S. Cl. CPC G01N 30/16; G01N 30/88; G01N 30/482; G01N 30/68; G01N 30/70; G01N 2030/8804; G01N 2030/025

(57) ABSTRACT

A method, system, and apparatus for analyzing the concentrations and amounts of one or more different compounds comprises filling a chromatographic column with at least two packing materials in serial, inserting a mobile phase into the chromatographic column, injecting a sample compound into the chromatographic column, and determining at least one constituent compound in the sample compound as the sample compound elutes through the chromatographic column.

### FIELD OF THE INVENTION

Embodiments are generally related to drilling and/or environmental operations. Embodiments are additionally related to well logging techniques utilized during drilling operations. Embodiments are also related to methods and systems for producing fast and accurate chromatographic readings.

### BACKGROUND

In oil well drilling operations, it has been common in the past to provide a log of the drilling operation that is indicative of the nature of the earth formation through which the drill bit is penetrating. The log enables the drilling operator to ascertain the presence of oil or gas in the formation being drilled and also the location of such oil or gas in the well.

In a majority of prior art mud logging systems, the information recorded at the surface of the well is generally done on a manual basis. All of the measurements and the measuring equipment require constant supervision so a logging operation generally involves significant human resources and time.

Logging techniques generally require the use of gas chromatography to ascertain the presence of different hydrocarbon species in the material being returned. Gas chromatography involves taking samples of gas and passing that gas through special columns filled with materials that allow different gases to flow at different rates. A disadvantage of the prior art chromatographic gas analysis technique results from the fact that chromatographic processes are generally very slow. Such techniques create a bottleneck that requires significant operator time and reduces efficiency.

Based on the foregoing, it is believed that a need exists for an improved chromatographic systems and methods for use in oil and gas extraction.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved well logging during drilling.

It is another aspect of the present invention to provide for an improved system and method for analyzing the concentrations and amounts of one or more different gases in oil and gas extraction operations.

The aforementioned aspects and other objectives and advantages can now be achieved as described herein. A method, system, and apparatus for analyzing the concentrations and amounts of one or more different compounds comprises filling a chromatographic column with at least two packing materials, inserting a mobile phase into the chromatographic column, injecting a sample compound into the chromatographic column, and determining at least one constituent compound in the sample compound as the sample compound elutes through the chromatographic column.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing the major components of a gas chromatograph system, in accordance with an alternative embodiment;

FIG. 2 illustrates an exploded view of a stagger packed chromatograph column in accordance with an alternative embodiment;

FIG. 3A illustrates a schematic representation of a stagger packed chromatograph column in accordance with an alternative embodiment;

FIG. 3B illustrates a schematic representation of a stagger packed chromatograph column in accordance with an alternative embodiment;

FIG. 3C illustrates a schematic representation of a stagger packed chromatograph column in accordance with an alternative embodiment and

FIG. 4 illustrates a block diagram of a computer system which is implemented in accordance with the disclosed embodiments;

FIG. 5 illustrates a flow chart depicting logical operational steps for evaluating the content of a gas mixture in accordance with an alternative embodiment of the invention; and

FIG. 6 illustrates a flow chart depicting logical operational steps for stagger packing a stagger packed chromatographic column in accordance with an alternative embodiment of the invention.

### DETAILED DESCRIPTION

The particular values and configurations discussed in these non-limiting examples can be varied and are cited merely to illustrate at least one embodiment and are not intended to limit the scope thereof.

A gas chromatograph, such as gas chromatograph system 100, is used to find the amounts of each of the gases present in a sample gas such as sample gas 111. In oil and gas operations, it is common for an oil and gas system to extract unknown samples of compounds, usually gas. These sample gases contain various constituent compounds, most commonly hydrocarbons. It is essential to the oil and gas operation to determine the relative amounts of these hydrocarbons as fast as possible. Gas chromatography is a known method for determining the quantities of hydrocarbon. Gas chromatography generally requires a carrier gas or “mobile phase” to propagate a sample gas through a stationary phase held within tubing. As the gas propagates through the tubing, the sample gas interacts with the stationary phase. This causes the constituent compounds of the sample gas to elute at different times. The retention time for each of the constituent compounds of the sample gas provides an analytic tool for evaluating the constituent make up of the sample gas.

For example, in oil and gas applications, it is important to identify the constituent gases present in samples from a well. Generally, methane will first be measured as a pulse at, for example, recorder 130 as it elutes. This is generally followed by ethane, propane, isobutane, and normal butane in order of ascending molecular weight. As is well known, the chromatograph will measure the first gas to elute from the column which is methane. After the methane is measured, the second gas to be released from the column may be ethane, after it is measured the next will be propane, and so forth to pentane. Stagger packing a column, such as column 120, can drastically reduce the processing time associated with the detection of each species of hydrocarbon.

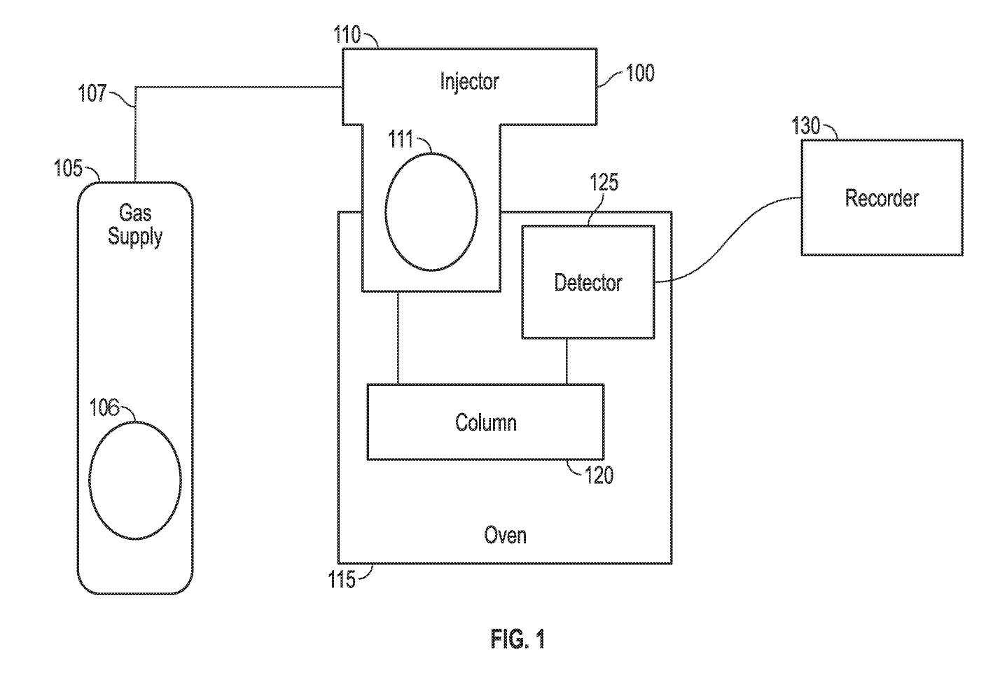

Referring to FIG. 1, a block diagram showing the major components of a gas chromatograph system 100 for use in oil and gas extraction is illustrated, in accordance with an embodiment. The system 100 includes a stagger packed chromatographic column 120. In FIG. 1 for purposes of illustration, the block diagram shown is more specifically directed to a chromatograph being used for the analysis of gas associated with drilling operations. However, it should be appreciated that the stagger packed column 120 associated with system 100 could alternatively be implemented in any number of capacities associated with oil and gas extraction, or other gas chromatography applications including, but not limited to, food and beverage analysis, analysis of acids, and the like.

In system 100, a gas supply 105 is used to direct a supply of gas 106, which is commonly configured as a “mobile phase” to the stagger packed column 120. A gas supply 105 can commonly be embodied as a gas tank or gas cylinder. In this case, a carrier gas can be stored at pressure in the gas tank 105. The gas tank can be fitted with reducing valves (not shown) configured to supply gas 106 to the stagger packed column 120 via a network of conduit 107.

Alternatively, gas supply 106 can be embodied as an air generator, which requires some kind of external gas source, and transmits gas 106 to stagger packed column 120 via conduit 107. It should be appreciated that gas 106 can comprise a mobile phase and can be atmospheric gas, nitrogen, hydrogen, helium or any other gas suitable for the specific application. It is common for the mobile phase gas to be selected to be inert or un-reactive. In addition, any combination of pressure controllers, flow controllers, and flow programmers may be necessarily included as needed to supply air to stagger packed column 120 at the required pressure for the desired application.

System 100 also includes an injector 110. In general, injector 110 is used to inject a sample gas 111 into the stagger packed column 120. It is common for injector 110 to inject a volume of sample gas 111 into the stagger packed column 120. That volume may range from 0.5 ml to 5 ml. The injector 110 generally injects sample gas 111 directly into the stagger packed column 120, although the injector may also inject the sample gas 111 into a flash heater (not shown) before it is injected into the stagger packed column 120.

Stagger packed column 120, is configured of a long tubular enclosure or pipe and is commonly kept in an oven 115, along with detector 125, and in some cases injector 110. In a preferred embodiment the stagger packed column 120 is made of stainless steel or glass, but other materials may also be used as necessary. One advantage of stainless steel is that it is better suited to tolerate elevated pressures. Stagger packed column 120 can be straight, u-shaped, or formed as a coil to save space, and may range in lengths.

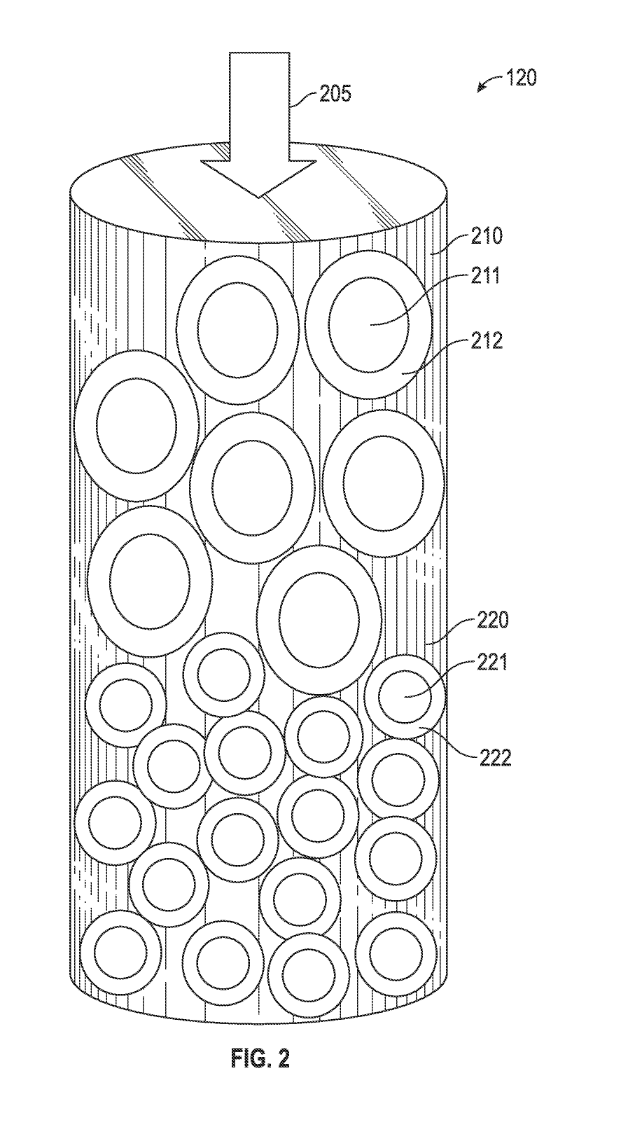

In addition, stagger packed column 120 is filled with at least one, and preferably 2 or more packing materials as shown in FIG. 2. In general, gas chromatographs are packed with adsorbents or with supports. In FIG. 2, stagger packed column 120 is illustrated with a mobile phase shown by arrow 205 and a stagger pack of packing material 210 and 220. A stationary phase such as stationary phase 212 associated with packing material 210 and stationary phase 222 associated with packing material 220 can be coated on an absorbent or support such as 211 and 221, respectively. The selected packing material 210 and 220 can be screened to a particular mesh ranging from 30-60 mesh to 100-120 mesh. The supports 211 and 221 used in stagger packed column 120 can include Celite, fire-brick, coated fire-brick, glass beads, Teflon chips, polymer beads, Chromosorb p, Chromosorb W, Chromosorb G, and/or Chromosorb S.

The supports are coated with a carefully recorded amount of stationary phase 212 and 222. It is important that the coating of the stationary phase be even and homogenous over the support to ensure elution occurs as expected.

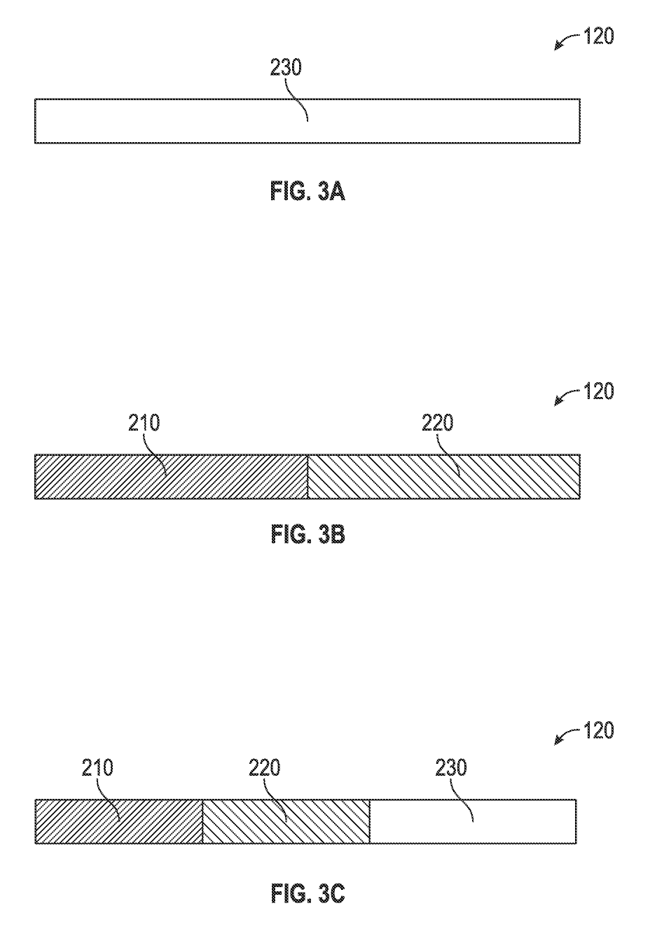

FIG. 3A illustrates a stagger packed column 120 filled with a 90-100 mesh packing material 230. For purposes of example, stagger packed column 120 is 64 inches in length. Other lengths of stagger packed column may be used equivalently and the length of stagger packed column 120 is provided solely for purposes of illustration.

Assuming stagger packed column 120 is 64 inches long, 22.6 grams of packing material 230 will be used to fill stagger packed column 120. In FIG. 3A, stagger packed column 120 is illustrated as being filled with 22.6 grams of 90-100 mesh packing material 230.

In this example, at 0 PSI stagger packed column 120 will complete the chromatographic process and render a reading via detector 125 and recorder 130 in approximately two and a half minutes.

FIG. 3B illustrates stagger packed column 120 filled with two separate packing materials, material 210 and material 220. In this example, as above, assuming stagger packed column 120 is 64 inches long, the total mass of material 210 and material 220 must equal 22.6 grams. In addition, it is critically important to note that material 210 is “stagger packed” on top of (or in series with) material 220. The phrase “in series,” or “serial” as used herein is meant to describe an arrangement wherein materials are added to the stagger packed column 120, one on top of the next, wherein the material is not intentionally mixed. By stagger packing stagger packed column 120 with materials 210 and 220, the total time to determine the various hydrocarbon quantities can be reduced.

Likewise, FIG. 3C illustrates stagger packed column 120 filled with three separate packing materials, material 210, material 220, and material 230 packed in stagger packed column 120 on top of (or in series with) each other. It should be appreciated that packing materials 210, 220, and 230 can include any of the aforementioned absorbents or supports coated with a stationary phase as shown in FIG. 2. In addition, packing materials 210, 220, and 230 can also be different mesh. For example, again assuming stagger packed column 120 is 64 inches long, material 230 could be 90-100 mesh and have a mass of 8 grams, material 220 could be 60-80 mesh and have a mass of 7 grams, and material 210 could be 30-60 mesh and have a mass of 7.6 grams. It is once again important to note that the total mass of all three materials 210, 220, and 230 sums to the mass of packing material that would normally fill the stagger packed column if it were not stagger packed.

It should be appreciated that the use of three materials, shown in FIG. 2C, is illustrative of the principle that stagger packed column 120 can be packed with any number of different packing materials so long as the total mass of the packing material is equal to the mass of packing material that would fill the stagger packed column 120 if it were not stagger packed. The stagger packed column 120 greatly reduces the time required to obtain a reading from the gas chromatograph system 100. In addition, the required pressure provided by gas 106 can be reduced by stagger packing stagger packed column 120.

The specific type of packing material (i.e. the stationary phase and support or absorbent selected), order of packing materials in the stagger packed column 120, individual mass of each packing material, total mass of packing material, and column length associated with the stagger packed column 120 can be adjusted to fit the desired application to provide the fastest possible reading from system 100. Because the bottleneck in traditional gas chromatograph systems is the time between the injection of a sample in the chromatographic column and the resulting detection after the samples constituent hydrocarbons elute through the column, replacing a traditional chromatographic column with a stagger packed column 120 greatly increase the efficiency of the system.

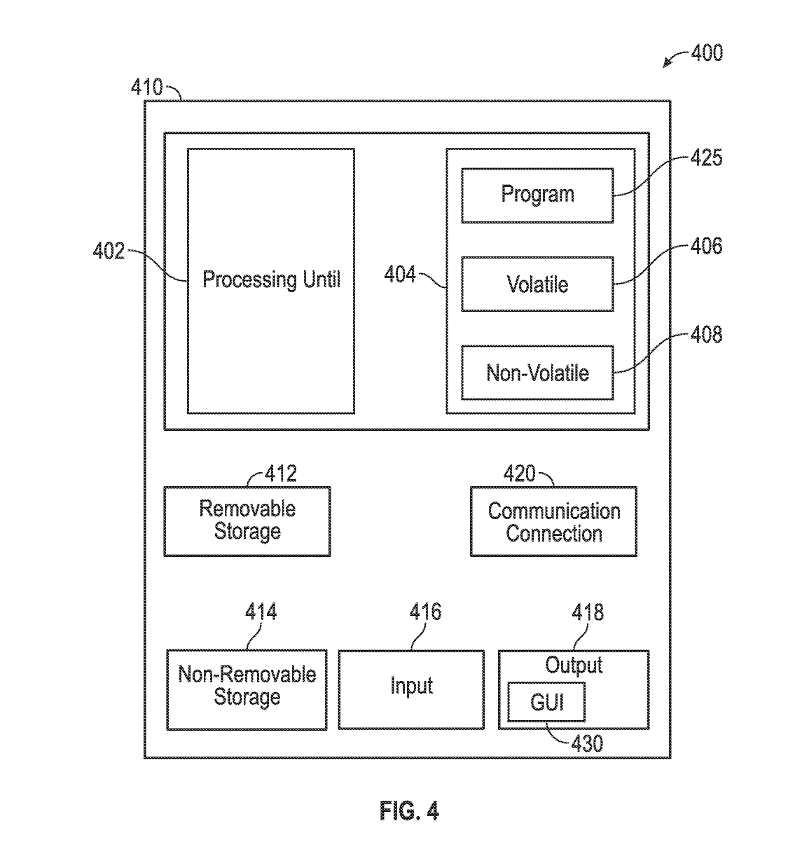

System 100 includes a detector 125 for detecting the elution of the constituent compounds in the sample gas 111. Detector 125 can be a flame ionization detector, nitrogen phosphorus detector, electron capture detector, or katharometer detector. The detector can be selected according to the requirements of the specific application. The detector 125 can be connected to a recorder 130 that is configured to accept detections from the detector 125 and provide them to a user. The record may be any known recorder including, but not limited to, a computer system as shown in FIG. 4 or other such electronic device. The detections from the detector can be displayed and/or saved on the recorder, and can provide data indicative of the presence of specific compounds in the sample gas 111 and relative quantities of those compounds.

A block diagram of a computer system 400 that executes programming for implementing the methods and systems disclosed herein is shown in FIG. 4. A general computing device in the form of a computer 410 may include a processing unit 402, memory 404, removable storage 412, and non-removable storage 414. Memory 404 may include volatile memory 406 and non-volatile memory 408. Computer 410 may include or have access to a computing environment that includes a variety of transitory and non-transitory computer-readable media such as volatile memory 406 and non-volatile memory 408, removable storage 412 and non-removable storage 414. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data, including data comprising frames of video.

Computer 410 may include or have access to a computing environment that includes input 416, output 418, and a communication connection 420. The computer may operate in a networked environment using a communication connection to connect to one or more remote computers or devices. The remote computer may include a personal computer (PC), server, router, network PC, a peer device or other common network node, or the like. The remote device may include a detector, recorder, or automation control unit for automatically completing any number of functions associated with system 100. The communication connection may include a Local Area Network (LAN), a Wide Area Network (WAN) or other networks.

Output 418 is most commonly provided as a computer monitor, but may include any computer output device. Output 418 may also include a data collection apparatus associated with computer system 400. In addition, input 416, which commonly includes a computer keyboard and/or pointing device such as a computer mouse, computer track pad, or the like, allows a user to select and instruct computer system 400. A user interface can be provided using output 418 and input 416. Output 418 may function as a display for displaying data and information for a user and for interactively displaying a graphical user interface (GUI) 430 associated with the data collected by detector 125.

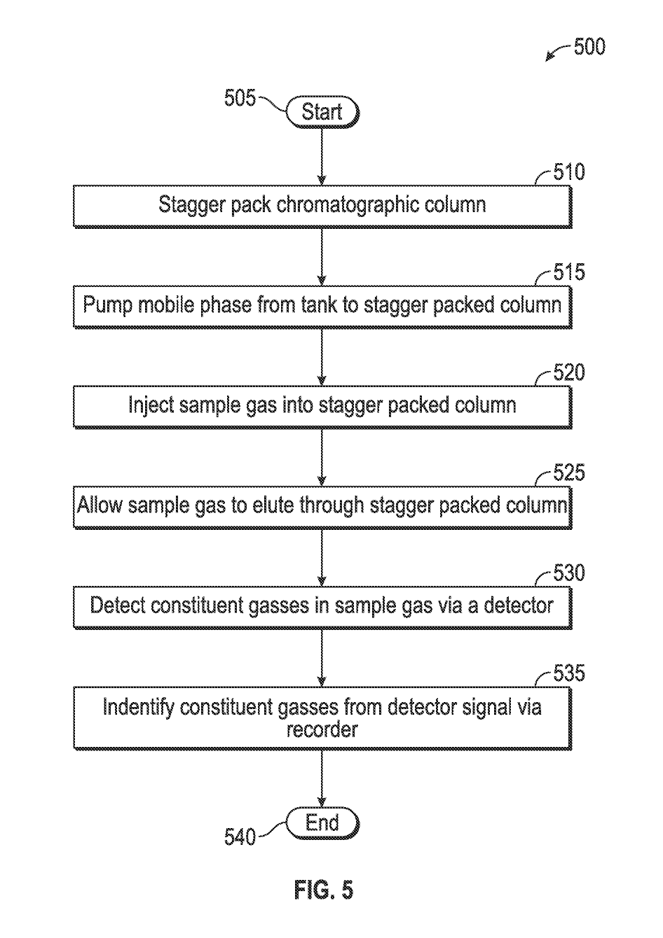

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 416 such as, for example, a pointing device such as a mouse and/or with a keyboard. A particular item can function in the same manner to the user in all applications because the GUI provides standard software routines (e.g., module 425) to handle these elements and report the user's actions. The GUI can further be used to display data collected by detector 125 and to automate various functions of system 100, or to implement various steps described below in FIG. 5.

Computer-readable instructions, for example, program module 425, which can be representative of other modules described herein, are stored on a computer-readable medium and are executable by the processing unit 402 of computer 410. Program module 425 may include a computer application. A hard drive, CD-ROM, RAM, Flash Memory, and a USB drive are just some examples of articles including a computer-readable medium.

FIG. 5 illustrates a set of logical operational steps for efficiently evaluating the content of a gas mixture. The method begins at block 505. In preparation, at block 510 a stagger packed column should be prepared with at least two stationary phase materials filled in the column in serial as described above. A mobile phase carrier gas can then be pumped from a tank to a stagger packed column as shown at block 515. In addition, a sample gas can be extracted from the test source and injected into the stagger packed column as illustrated by block 520.

Block 525 explains that elution will occur in the stagger packed column separating the constituent gasses out of the sample gas. At block 530, a detector is used to detect the constituent gases as they elute. The constituent gases can then be identified using a recorder at block 535 and the method ends at block 540.

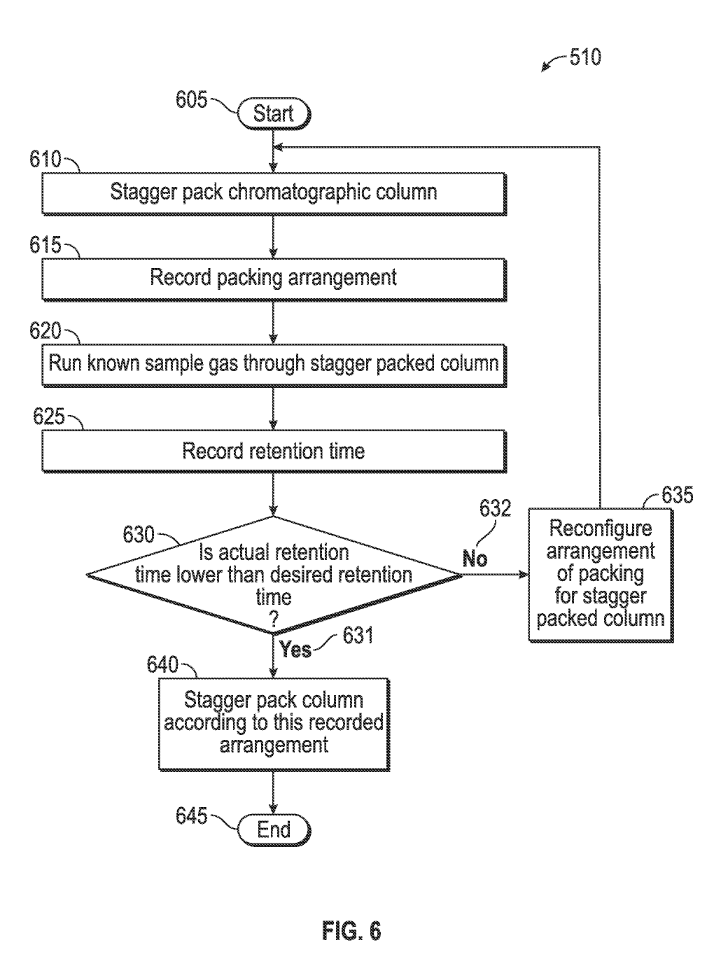

FIG. 6 illustrates a set of logical operational steps for packing a stagger packed column 120, as shown at step 510 in FIG. 5. The method begins at step 605. The first step is to pack a stagger packed chromatographic column 120 with at least two packing materials such as 210 and 220 shown at step 610. It is critically important to carefully record the packing arrangement used as illustrated at block 615. For example, the record should indicate the types of packing material used including the support and stationary phase, the respective mesh sizes, the amounts of each packing material, the order of the serially packed material, and the size of the column used, etc.

Next at step 620, a known quantity of a known sample gas, which includes known constituent compounds can be run through the stagger packed column. It is important to note the retention time for each constituent gas, and include this in the record developed at step 615. This actual retention time for the configuration can then be compared to a desired retention time as shown at step 630. If the actual retention time is less than the desired retention time at step 631, then the stagger packed column 120 can be stagger packed according to this arrangement as shown at step 640. However, if the actual retention time is longer than the desired retention time at step 632, the arrangement of packing materials can be reconfigured as shown at step 635. The reconfigured arrangement of packing materials can then be stagger packed into a stagger packing column at step 610. The process can be iteratively repeated until the actual retention time is lower than the desired retention time, thereby yielding a highly efficient stagger packing arrangement for use in a stagger packed column such as stagger packed column 120.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims. For example, a method for analyzing the concentrations and amounts of one or more different compounds comprise filling a chromatographic column with at least two packing materials, inserting a mobile phase into the chromatographic column, injecting a sample compound into the chromatographic column, and determining at least one constituent compound in the sample compound as the sample compound elutes through the chromatographic column.

In another embodiment, the chromatographic column is packed in serial. The method further comprises filling the chromatographic column with an arrangement of at least two packing materials, eluting a known sample compound through the filled chromatographic column to determine if the actual retention time is less than a goal retention time, and then iteratively rearranging the arrangement of the packing materials and eluting the known sample compound through the filled chromatographic column until the actual retention time is less than the goal retention time to define a final arrangement of the at least two packing materials. The chromatographic tube can then be filled according to the final arrangement of the at least two packing materials.

In another embodiment, the method includes rearranging the arrangement of the at least two packing materials by adjusting the number of the at least two packing materials, adjusting the size of the at least two packing materials, adjusting the type of the at least two packing materials, and adjusting the order of the at least two packing materials.

In yet another embodiment, each of said at least two packing materials comprises a support and a stationary phase. Each of the supports for the at least two packing materials comprises at least one of: Celite, fire-brick, coated fire-brick, glass beads, Teflon chips, polymer beads, Chromosorb p, Chromosorb W, Chromosorb G, and Chromosorb S.

In an alternative embodiment, the method can further comprise pumping the mobile phase from a tank to the chromatographic column, holding the sample compound in an injector before it is injected into the chromatographic column, heating the chromatographic column with a heater, detecting the at least one constituent compound with a detector, and recording the detected constituent compound using a recorder. The recorder comprises a computer system.

In another alternative embodiment, a system for analyzing the concentrations and amounts of one or more different compounds comprises a chromatographic column, at least two packing materials disposed in said chromatographic column, a sample compound injected into the chromatographic column in combination with a mobile phase, and a detector configured to determine at least one constituent compound associated with the sample compound. The at least two packing materials are arranged in serial in the chromatographic column.

In another embodiment of the system, each of said at least two packing materials comprise a support and a stationary phase, wherein each of the supports for each of the at least two packing materials comprise at least one of: Celite, fire-brick, coated fire-brick, glass beads, Teflon chips, polymer beads, Chromosorb p, Chromosorb W, Chromosorb G, and Chromosorb S.

The system can further comprise a pressurized tank configured to contain the mobile phase, a conduit for transferring the mobile phase from the tank to the chromatographic column, an injector for injecting the sample compound into the chromatographic column, a heater configured to heat the chromatographic column, and a recorder configured to record a detection signal provided by the detector. The recorder comprises a computer and the sample compound comprises a sample gas.

In yet another embodiment, an apparatus for analyzing the concentrations and amounts of one or more different gases comprises a chromatographic column, at least two packing materials disposed in the chromatographic column, a sample gas injected into the chromatographic column in combination with a mobile phase, and a detector configured to determine at least one constituent compound associated with the sample compound.

The apparatus further comprising a pressurized tank configured to contain the mobile phase, a conduit for transferring the mobile phase from the tank to the chromatographic column, an oil and gas extraction system configured to collect the sample gas, an injector for injecting the sample gas into the chromatographic column, a heater configured to heat the chromatographic column and the injector, and a recorder configured to record a detection signal provided by the detector. The at least two packing materials are arranged in serial in the chromatographic column.

The apparatus further comprises at least two packing materials disposed in the chromatographic column according to a total number of the at least two packing materials, the respective size of the at least two packing materials, the types of the at least two packing materials, and the order of the at least two packing materials.

In another embodiment, each of said at least two packing materials comprises a support and a stationary phase, wherein each of the supports for the at least two packing materials comprise at least one of Celite, fire-brick, coated fire-brick, glass beads, Teflon chips, polymer beads, Chromosorb p, Chromosorb W, Chromosorb G, and Chromosorb S.

In another embodiment, the detector comprises one of a flame ionization detector, a nitrogen phosphorus detector, an electron capture detector, and a katharometer detector. The recorder comprises a computer.

What is claimed is:

1. A method for analyzing the concentrations and amounts of one or more different compounds comprising:
filling a chromatographic column with at least two packing materials;
inserting a mobile phase into said filled chromatographic column;
injecting a sample compound into said chromatographic column; and
determining at least one constituent compound in said sample compound as said sample compound elutes through said filled chromatographic column.

2. The method of claim 1 wherein filling said chromatographic column with at least two packing materials further comprises:
packing said at least two packing materials in serial in said chromatographic column.

3. The method of claim 2 wherein filling said chromatographic column with at least two packing materials further comprises:
filling said chromatographic column with an arrangement of said at least two packing materials;
eluting a known sample compound through said filled chromatographic column to determine if an actual retention time is less than a goal retention time;
iteratively rearranging said arrangement of said at least two packing materials and eluting said known sample compound through said filled chromatographic column until said actual retention time is less than said goal retention time thereby defining a final arrangement of said at least two packing materials; and
filling said chromatographic tube according to said final arrangement of said at least two packing materials.

4. The method of claim 3 wherein rearranging said arrangement of said at least two packing materials comprises at least one of:
adjusting a number of said at least two packing materials;
adjusting a size of said at least two packing materials;
adjusting a type of said at least two packing materials; and
adjusting an order of said at least two packing materials.

5. The method of claim 1 wherein each of said at least two packing materials comprises a support and a stationary phase, wherein each of said supports for said at least two packing materials comprise at least one of:
Celite;
fire-brick;
coated fire-brick;
glass beads;
Teflon chips;
polymer beads;
Chromosorb p;
Chromosorb W;
Chromosorb G; and
Chromosorb S.

6. The method of claim 1 further comprising:
pumping said mobile phase from a tank to said chromatographic column;
holding said sample compound in an injector before it is injected into said chromatographic column;
heating said chromatographic column with a heater;
detecting said at least one constituent compound with a detector; and
recording said detected constituent compound using a recorder.

7. The method of claim 6 wherein said recorder comprises a computer system.

8. A system for analyzing the concentrations and amounts of one or more different compounds comprising:
a chromatographic column;
at least two packing materials disposed in said chromatographic column;
a sample compound injected into said chromatographic column in combination with a mobile phase; and
a detector configured to determine at least one constituent compound associated with said sample compound.

9. The system of claim 8 wherein said at least two packing materials are arranged in serial in said chromatographic column.

10. The system of claim 9 wherein each of said at least two packing materials comprise a support and a stationary phase, wherein each of said supports for each of said at least two packing materials comprise at least one of:
Celite;
fire-brick;
coated fire-brick;
glass beads;
Teflon chips;
polymer beads;
Chromosorb p;
Chromosorb W;
Chromosorb G; and
Chromosorb S.

11. The system of claim 8 further comprising:
a pressurized tank configured to contain said mobile phase;
a conduit for transferring said mobile phase from said tank to said chromatographic column;
an injector for injecting said sample compound into said chromatographic column;
a heater configured to heat said chromatographic column; and
a recorder configured to record a detection signal provided by said detector.

12. The system of claim 11 wherein said recorder comprises a computer.

13. The system of claim 8 wherein said sample compound comprises a sample gas.

14. An apparatus for analyzing the concentrations and amounts of one or more different gases comprising:
a chromatographic column;
at least two packing materials disposed in said chromatographic column;
a sample gas injected into said chromatographic column in combination with a mobile phase; and
a detector configured to determine at least one constituent compound associated with said sample compound.

15. The apparatus of claim 14 further comprising:
a pressurized tank configured to contain said mobile phase;
a conduit for transferring said mobile phase from said tank to said chromatographic column;
an oil and gas extraction system configured to collect said sample gas;
an injector for injecting said sample gas into said chromatographic column;
a heater configured to heat said chromatographic column and said injector; and
a recorder configured to record a detection signal provided by said detector.

16. The apparatus of claim 15 wherein said at least two packing materials are arranged in serial in said chromatographic column.

17. The apparatus of claim 16 wherein said at least two packing materials are disposed in said chromatographic column according to:
a total number of said at least two packing materials;
a size of said at least two packing materials;
a type of said at least two packing materials; and
a serial order of said at least two packing materials.

18. The apparatus of claim 17 wherein each of said at least two packing materials comprises a support and a stationary phase, wherein each of said supports for said at least two packing materials comprise at least one of:
Celite;
fire-brick;
coated fire-brick;
glass beads;
Teflon chips;
polymer beads;
Chromosorb p;
Chromosorb W;
Chromosorb G; and
Chromosorb S.

19. The apparatus of claim 14 wherein said detector comprises one of:
a flame ionization detector,
a nitrogen phosphorus detector;
an electron capture detector; and
a katharometer detector.

20. The apparatus of claim 15 wherein said recorder comprises a computer.
